(19) United States
(12) Patent Application Publication
(10) Pub. No.: US 2026/0050200 A1
(43) Pub. Date: Feb. 19, 2026

(54) OPTICAL ELEMENT DRIVING MECHANISM

(71) Applicant: TDK TAIWAN CORP., Taoyuan City (TW)

(72) Inventor: Yi-Ho CHEN, Taoyuan City (TW)

(21) Appl. No.: 19/296,509

(22) Filed: Aug. 11, 2025

Related U.S. Application Data
(60) Provisional application No. 63/683,803, filed on Aug. 16, 2024.

(51) Int. Cl. G03B 5/00

(52) U.S. Cl. CPC G03B 5/00; G03B 2205/0007

(57) ABSTRACT

An optical element driving mechanism is provided. The optical element driving mechanism includes a first movable portion, a fixed portion, a driving component, and a connecting component. The first movable portion is configured to connect the optical element. The first movable portion is movable relative to the fixed portion. The driving component is configured to drive the first movable portion to move relative to the fixed portion. The first movable portion is movable relative to the fixed portion via the connecting component.

### CROSS REFERENCE TO RELATED APPLICATIONS

This application claims the benefit of U.S. Provisional Application No. 63/683,803, filed Aug. 16, 2024, the entirety of which is incorporated by reference herein.

### BACKGROUND OF THE INVENTION

### Field of the Invention

The present invention relates to an optical element driving mechanism, and in particular it relates to an optical element driving mechanism that includes a connecting component.

### Description of the Related Art

With the continuous evolution of smart electronic devices, the integration of photography and video recording functions has become increasingly prevalent, driving development toward smaller form factors and highly integrated modules. To meet demands for better image quality and optical image stabilization (OIS), many modern optical element driving mechanisms have adopted multiple independently movable portions and multi-axis driving designs to achieve more precise image adjustment. These optical element driving mechanisms typically include more than two movable portions coupled to respective axial driving components via connecting components, allowing the optical element to be compensated for and adjusted along multiple axes.

However, with existing technologies, optical element driving mechanisms often suffer from mutual interference between movable portions during operation due to a lack of appropriate decoupling designs, which can affect the stability and control accuracy of the module. Furthermore, current structures lack designs that simultaneously provide both guidance and tolerance compensation, resulting in overall movement that is not smooth. Therefore, how to achieve decoupled motion among multiple axes while ensuring the stability and supporting strength of the connecting components is a technical challenge that remains to be addressed.

### BRIEF SUMMARY OF THE INVENTION

The present invention provides an optical element driving mechanism, which includes a first movable portion, a fixed portion, a driving component, and a connecting component. The first movable portion is configured to connect the optical element. The first movable portion is movable relative to the fixed portion. The driving component is configured to drive the first movable portion to move relative to the fixed portion. The first movable portion is movable relative to the fixed portion via the connecting component.

According to some embodiments of the present disclosure, the connecting component includes a first connecting element and a second connecting element. The first movable portion is movable relative to the fixed portion via the first connecting element. The first movable portion is movable relative to the fixed portion via the second connecting element. The first connecting element is movable relative to the fixed portion, and the second connecting element is movable relative to the fixed portion.

### BRIEF DESCRIPTION OF THE DRAWINGS

The following is described in detail with reference to the accompanying drawings. It should be noted that, in accordance with standard practice in the industry, various features are not drawn to scale and are only used for illustration purposes. In fact, the size of the components may be arbitrarily enlarged or reduced to clearly show the features of the present disclosure.

FIG. 1 is a perspective view of an optical element driving mechanism according to some embodiments of the present disclosure.

FIG. 2 is an exploded view of the optical element driving mechanism according to some embodiments of the present disclosure.

FIG. 3 is a top view of a first movable portion, a first stabilizing element of a first stabilizing portion, and a first stabilizing element of a second stabilizing portion according to some embodiments of the present disclosure, wherein the first movable portion is shown in dotted lines for illustrative purposes.

FIG. 4 is a top view of a portion of the optical element driving mechanism according to some embodiments of the present disclosure.

FIG. 5 is a bottom view of a first connecting element, a second connecting element, a third stabilizing element of the first stabilizing portion, and a third stabilizing element of the second stabilizing portion according to some embodiments of the present disclosure, wherein the first connecting element and the second connecting element are shown in dotted lines for illustrative purposes.

FIG. 6 is a cross-sectional view of the optical element driving mechanism taken along line A-A′ of FIG. 1.

FIG. 7 is a top view of a first connecting element, a second connecting element, a first connecting portion, a second connecting portion, a third connecting portion, a fourth connecting portion and a second stabilizing element according to some embodiments of the present disclosure, wherein the first connecting element and the second connecting element are shown in dotted lines for illustrative purposes.

FIG. 8 is a cross-sectional view of the optical element driving mechanism taken along line B-B′ of FIG. 1.

FIG. 9A and FIG. 9B are schematic cross-sectional views of a first corresponding portion of the first connecting element and a seventh corresponding portion of the second connecting element, respectively, according to some embodiments of the present disclosure.

### DETAILED DESCRIPTION OF THE INVENTION

Unless otherwise defined, all terms, including technical and scientific terms, used herein have the same meanings as commonly understood by one of ordinary skill in the art. It is understood that these terms, such as those defined in commonly used dictionaries, should be interpreted as having a meaning consistent with the background or context of the relevant technology and the present invention, and should not be interpreted in an idealized or overly formal manner unless specifically defined herein.

Furthermore, the ordinal numbers used in the specification and claims, such as “first”, “second”, etc., to modify the elements of the claims, do not themselves imply or represent any previous ordinal numbers of the claimed elements, nor do they represent the order of one element and another element, or the order in the manufacturing method. The use of such ordinal numbers is only configured to clearly distinguish one element with a certain name from another element with the same name.

In addition, in some embodiments of the present disclosure, terms such as “connection”, “interconnection”, etc., unless otherwise defined, may refer to two structures being in direct contact, or may refer to two structures not being in direct contact, with another structure disposed between the two structures. Such terms may also include situations where both structures are movable, or both structures are fixed.

In the description of this specification, the description with reference to the terms “one embodiment”, “some embodiments”, “example”, etc. means that the specific features, structures, materials or characteristics described in conjunction with the embodiment or example are included in at least one embodiment or example of the present disclosure. In this specification, the schematic representations of the above terms do not necessarily refer to the same embodiment or example. Moreover, the specific features, structures, materials or characteristics described may be combined in any one or more embodiments or examples in a suitable manner. In addition, a person of ordinary skill in the art may combine different embodiments or examples described in this specification.

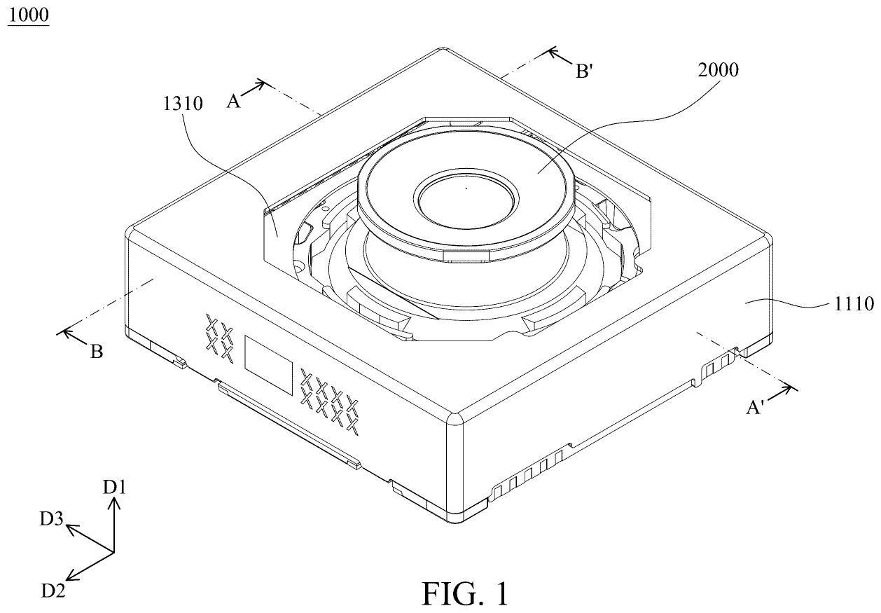

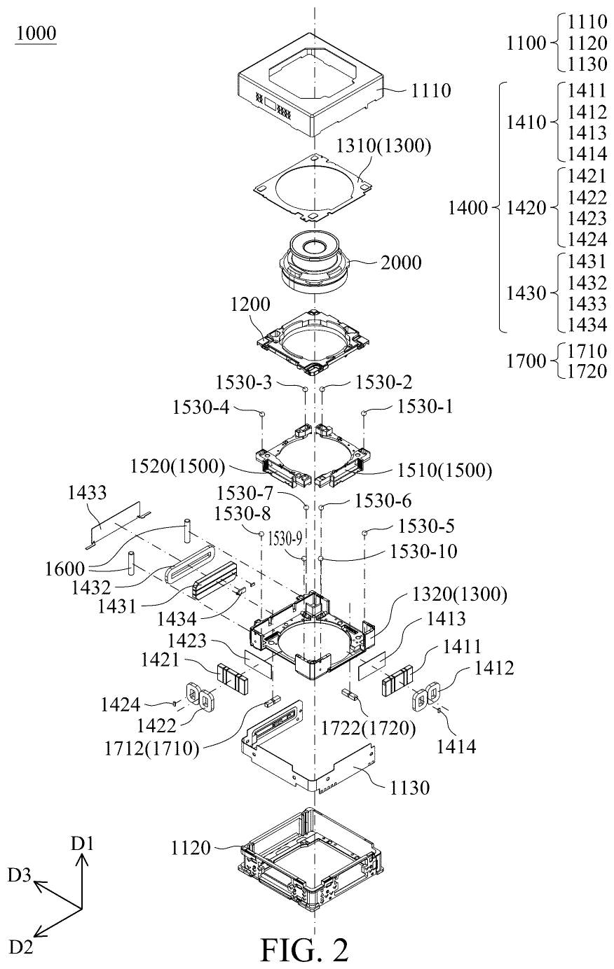

FIG. 1 is a perspective view of an optical element driving mechanism 1000 according to some embodiments of the present disclosure. FIG. 2 is an exploded view of the optical element driving mechanism 1000 according to some embodiments of the present disclosure. The overall structure of the optical element driving mechanism 1000 is described in detail below, with reference to FIG. 1 and FIG. 2.

According to some embodiments of the present disclosure, the optical element driving mechanism 1000 includes a fixed portion 1100, a first movable portion 1200, a second movable portion 1300, a driving component 1400, a connecting component 1500, guiding elements 1600, and a stabilizing component 1700.

According to some embodiments of the present disclosure, the fixed portion 1100 includes a housing 1110, a base 1120 and a circuit member 1130. The housing 1110 is fixedly connected to the base 1120 to form a receiving space for receiving other components of the optical element driving mechanism 1000. The circuit member 1130 is fixedly disposed on the base 1120.

According to some embodiments of the present disclosure, the first movable portion 1200 is movable relative to the fixed portion 1100. The first movable portion 1200 is configured to connect an optical element 2000. In other words, the first movable portion 1200 is a holder that holds the optical element 2000.

According to some embodiments of the present disclosure, the second movable portion 1300 is movable relative to the fixed portion 1100 on a first axis D1 to achieve an optical effect of autofocus. On the other hand, the first movable portion 1200 is movable relative to the fixed portion 1100 on a second axis D2 and a third axis D3 to achieve an optical effect of optical image stabilization.

According to some embodiments of the present disclosure, the second movable portion 1300 includes an upper cover 1310 and a body 1320. The upper cover 1310 of the second movable portion 1300 is fixedly connected to the body 1320 to form a space for accommodating the first movable portion 1200.

According to some embodiments of the present disclosure, the driving component 1400 is configured to drive the first movable portion 1200 and the second movable portion 1300 to move relative to the fixed portion 1100. The driving component 1400 includes a first driving unit 1410, a second driving unit 1420 and a third driving unit 1430.

According to some embodiments of the present disclosure, the first driving unit 1410 includes a magnetic element 1411, a pair of coils 1412, a magnetically permeable element 1413, and a sensing element 1414. The second driving unit 1420 includes a magnetic element 1421, a pair of coils 1422, a magnetically permeable element 1423, and a sensing element 1424. The third driving unit 1430 includes a magnetic element 1431, a pair of coils 1432, a magnetically permeable element 1433, and a sensing element 1434.

According to some embodiments of the present disclosure, the first movable portion 1200 is movable relative to the fixed portion 1100 via the connecting component 1500. The connecting component 1500 includes a first connecting element 1510, a second connecting element 1520, a first connecting portion 1530-1, a second connecting portion 1530-2, a third connecting portion 1530-3, a fourth connecting portion 1530-4, a fifth connecting portion 1530-5, a sixth connecting portion 1530-6, a seventh connecting portion 1530-7, an eighth connecting portion 1530-8, a ninth connecting portion 1530-9, and a tenth connecting portion 1530-10.

According to some embodiments of the present disclosure, the first connecting element 1510 is movable relative to the fixed portion 1100, and the second connecting element 1520 is movable relative to the fixed portion 1100. The first connecting element 1510 is movable relative to the second movable portion 1300, and the second connecting element 1520 is movable relative to the second movable portion 1300. The first movable portion 1200 is movable relative to the fixed portion 1100 via the first connecting element 1510. The first movable portion 1200 is movable relative to the fixed portion 1100 via the second connecting element 1520.

According to some embodiments of the present disclosure, the first connecting portion 1530-1 and the second connecting portion 1530-2 may be balls disposed between the first movable portion 1200 and the first connecting element 1510. The third connecting portion 1530-3 and the fourth connecting portion 1530-4 may be balls disposed between the first movable portion 1200 and the second connecting element 1520.

According to some embodiments of the present disclosure, the fifth connecting portion 1530-5, the sixth connecting portion 1530-6, and the tenth connecting portion 1530-10 may be balls disposed between the second movable portion 1300 and the first connecting element 1510. The seventh connecting portion 1530-7, the eighth connecting portion 1530-8, and the ninth connecting portion 1530-9 may be balls disposed between the second movable portion 1300 and the second connecting element 1520.

According to some embodiments of the present disclosure, the first movable portion 1200 is movable relative to the first connecting element 1510 via the first connecting portion 1530-1 and the second connecting portion 1530-2. The first movable portion 1200 is movable relative to the second connecting element 1520 via the third connecting portion 1530-3 and the fourth connecting portion 1530-4.

According to some embodiments of the present disclosure, the magnetic element 1411 of the first driving unit 1410 is disposed on the first connecting element 1510, and the coil 1412 is disposed on the circuit member 1130. The magnetic element 1421 of the second driving unit 1420 is disposed on the second connecting element 1520, and the coil 1422 is disposed on the circuit member 1130.

According to some embodiments of the present disclosure, the magnetically permeable components 1413 and 1423 have high magnetic permeability (e.g., iron, silicon steel sheets), and are capable of effectively guiding the path of magnetic flux, thereby concentrating the magnetic flux within the magnetic circuit formed by the coil and the magnet, enhancing the magnetic field strength and consequently increasing the magnetic force.

The magnetic element 1411 corresponds to the coil 1412. Specifically, when a driving signal (e.g., an electric current supplied by an external power source) is applied to the coil 1412, an electromagnetic actuation force is generated between the magnetic element 1411 and the coil 1412. This force drives the first movable portion 1200 to move along the second axis D2, thereby driving the optical element 2000 to a desired position.

Similarly, the magnetic element 1421 corresponds to the coil 1422. When a driving signal (e.g., an electric current supplied by an external power source) is applied to the coil 1422, an electromagnetic actuation force is generated between the magnetic element 1421 and the coil 1422. This force drives the first movable portion 1200 to move along the third axis D3, thereby driving the optical element 2000 to a desired position.

According to some embodiments of the present disclosure, the sensing elements 1414 and 1424 are respectively disposed on the circuit member 1130. The sensing elements 1414 and 1424 are configured to detect variations in the magnetic fields generated by the magnetic elements 1411 and 1421, respectively, and convert the detected variations into corresponding electrical signals, thereby enabling closed-loop control of the optical element driving mechanism 1000.

According to some embodiments of the present disclosure, the magnetic element 1431 of the third driving unit 1430 is disposed on the second movable portion 1300, and the coil 1432 is disposed on the base 1120. A magnetically permeable element 1433 is disposed on the circuit member 1130. In this manner, a magnetic attraction force generated between the magnetically permeable element 1433 and the magnetic element 1431 urges the second movable portion 1300 toward the side of the fixed portion 1100 on which the guiding elements 1600 are provided.

The magnetic element 1431 corresponds to the coil 1432. Specifically, when a driving signal (e.g., an electric current supplied by an external power source) is applied to the coil 1432, an electromagnetic actuation force is generated between the magnetic element 1431 and the coil 1432. This force drives the second movable portion 1300 to move along the first axis D1, thereby driving the optical element 2000 to a desired position.

According to some embodiments of the present disclosure, a sensing element 1434 is disposed on the circuit member 1130. The sensing element 1434 is configured to detect variations in the magnetic field generated by the magnetic element 1431 and convert the detected variations into corresponding electrical signals, thereby enabling closed-loop control of the optical element driving mechanism 1000.

According to some embodiments of the present disclosure, the guiding elements 1600 may be guide rods disposed adjacent to the third driving unit 1430. The guiding elements 1600 are positioned between the base 1120 and the second movable portion 1300 to guide the movement of the second movable portion 1300 relative to the fixed portion 1100.

According to some embodiments of the present disclosure, the stabilizing component 1700 is configured to apply a stabilizing force to the first movable portion 1200, such that the first movable portion 1200 remains in continuous contact with the connecting component 1500. The stabilizing component 1700 includes a first stabilizing portion 1710 and a second stabilizing portion 1720.

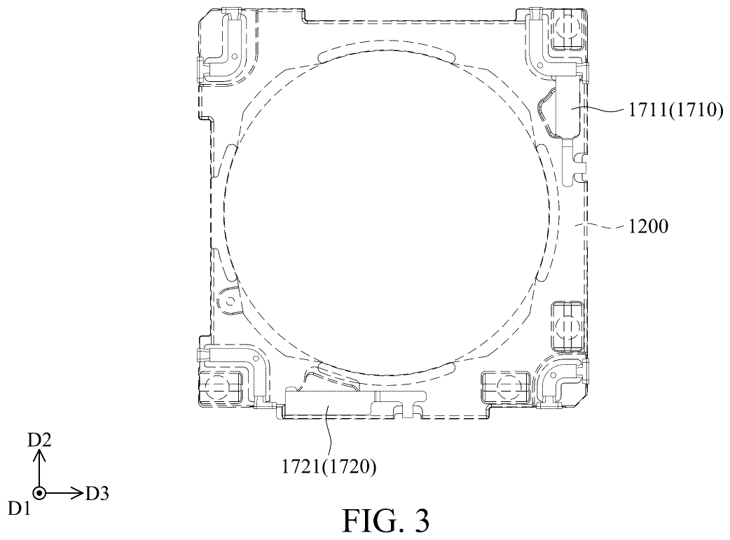

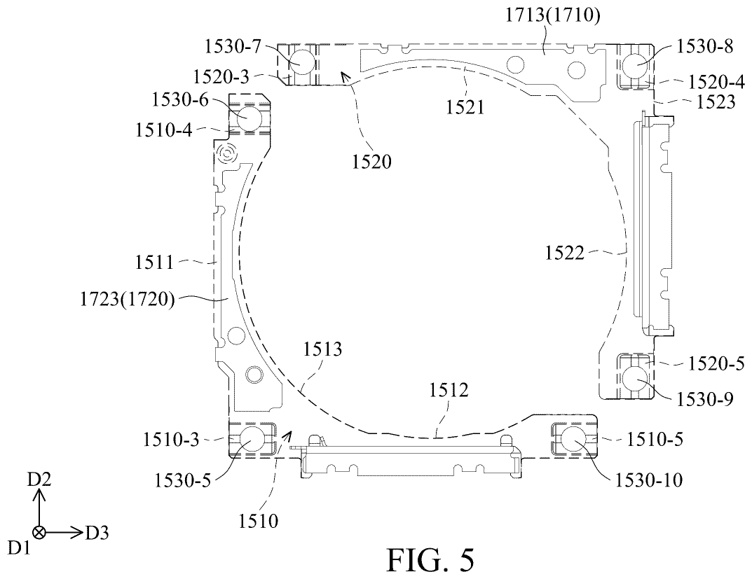

According to some embodiments of the present disclosure, the first stabilizing portion 1710 includes a first stabilizing element 1711 (FIG. 3), a second stabilizing element 1712, and a third stabilizing element 1713 (FIG. 5). The second stabilizing portion 1720 includes a first stabilizing element 1721 (FIG. 3), a second stabilizing element 1722, and a third stabilizing element 1723 (FIG. 5), the details of which are described in detail with respect to FIG. 3 and FIG. 5.

FIG. 3 shows a top view of the first movable portion 1200, the first stabilizing element 1711 of the first stabilizing portion 1710, and the first stabilizing element 1721 of the second stabilizing portion 1720 according to some embodiments of the present disclosure, wherein the first movable portion 1200 is shown in dotted lines for illustrative purposes.

As shown in FIG. 3, the first stabilizing element 1711 of the first stabilizing portion 1710 and the first stabilizing element 1721 of the second stabilizing portion 1720 are fixedly disposed in the first movable portion 1200. Specifically, the first stabilizing element 1711 of the first stabilizing portion 1710 and the first stabilizing element 1721 of the second stabilizing portion 1720 are at least partially embedded in the first movable portion 1200.

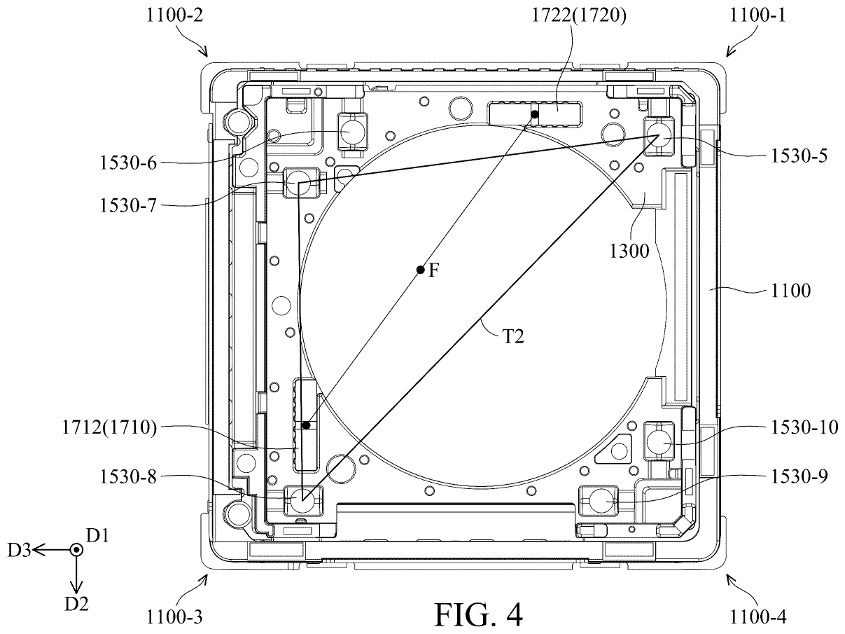

FIG. 4 is a top view of a portion of the optical element driving mechanism 1000 according to some embodiments of the present disclosure. As shown in FIG. 4, the second stabilizing element 1712 of the first stabilizing portion 1710 and the second stabilizing element 1722 of the second stabilizing portion 1720 are fixedly disposed on the second movable portion 1300.

According to some embodiments of the present disclosure, the second stabilizing elements 1712 and 1722 are disposed on the second movable portion 1300 and is movable relative to the fixed portion 1100. Since the first movable portion 1200 (FIG. 3) is movable relative to the second movable portion 1300, the first stabilizing elements 1711 and 1721 (FIG. 3) is movable relative to the second stabilizing elements 1712 and 1722.

FIG. 5 is a bottom view of the first connecting element 1510, the second connecting element 1520, the third stabilizing element 1713 of the first stabilizing portion 1710, and the third stabilizing element 1723 of the second stabilizing portion 1720 according to some embodiments of the present disclosure, wherein the first connecting element 1510 and the second connecting element 1520 are shown in dotted lines for illustrative purposes.

As shown in FIG. 5, the third stabilizing element 1713 of the first stabilizing portion 1710 is at least partially embedded in the second connecting element 1520, and the third stabilizing element 1723 of the second stabilizing portion 1720 is at least partially embedded in the first connecting element 1510. The first connecting element 1510 is movable relative to the second stabilizing elements 1712, 1722 (FIG. 4), and the second connecting element 1520 is movable relative to the second stabilizing elements 1712, 1722 (FIG. 4).

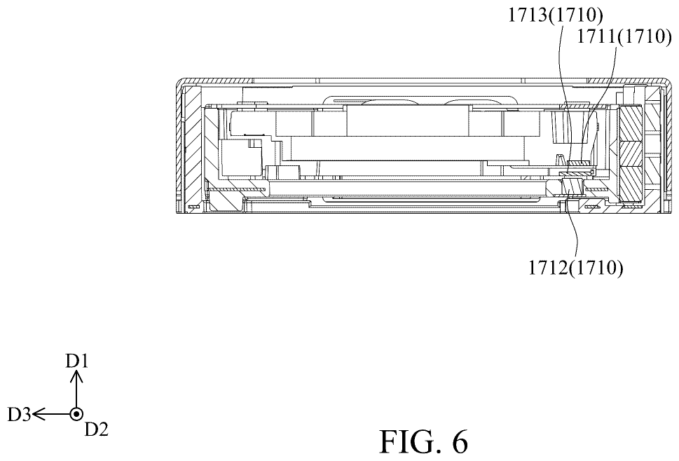

FIG. 6 is a cross-sectional view of the optical element driving mechanism 1000 taken along line A-A′ of FIG. 1. As shown in FIG. 6, when viewed along the first axis D1, the first stabilizing element 1711, the second stabilizing element 1712 and the third stabilizing element 1713 of the first stabilizing portion 1710 at least partially overlap.

According to some embodiments of the present disclosure, the first stabilizing portion 1710 is configured to generate a first stabilizing force. Specifically, the first stabilizing force is generated between the second stabilizing element 1712 and the first stabilizing element 1711 of the first stabilizing portion 1710 and between the second stabilizing element 1712 and the third stabilizing element 1713.

Although not shown in FIG. 6, similarly, the second stabilizing portion 1720 is configured to generate a second stabilizing force. Specifically, the second stabilizing force is generated between the second stabilizing element 1722 (FIG. 4) and the first stabilizing element 1721 (FIG. 3) of the second stabilizing portion 1720 and between the second stabilizing element 1722 and the third stabilizing element 1723 (FIG. 5).

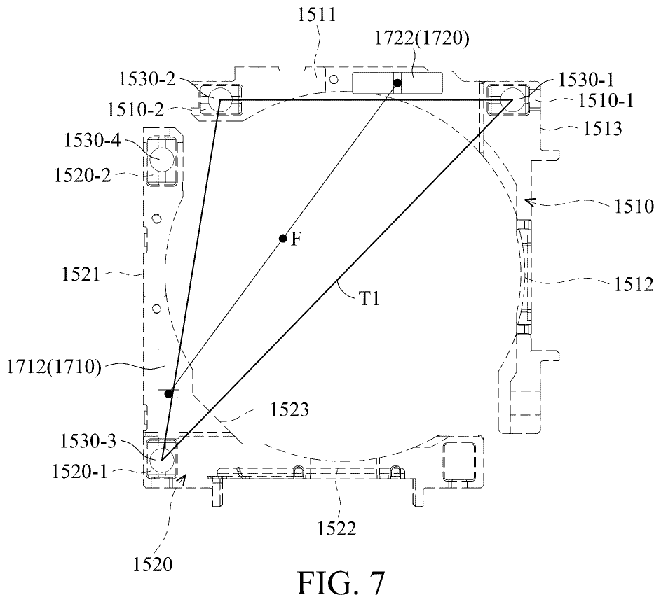

FIG. 7 is a top view of the first connecting element 1510, the second connecting element 1520, the first connecting portion 1530-1, the second connecting portion 1530-2, the third connecting portion 1530-3, the fourth connecting portion 1530-4 and the second stabilizing elements 1712 and 1722 according to some embodiments of the present disclosure, wherein the first connecting element 1510 and the second connecting element 1520 are shown in dotted lines for illustrative purposes.

As shown in FIG. 7, a stabilizing force F is at least composed of the first stabilizing force and the second stabilizing force (in the present embodiment, the stabilizing force F may be regarded as the resultant force of the first and second stabilizing forces). A first imaginary plane (which is parallel to a plane defined by the second axis D2 and the third axis D3) is defined by the first connecting portion 1530-1, the second connecting portion 1530-2, and the third connecting portion 1530-3.

As shown in FIG. 7, when viewed along a direction perpendicular to the first imaginary plane (e.g., along the positive or negative direction of the first axis D1), the point of application of the stabilizing force F is located in an imaginary position. When viewed along the direction perpendicular to the first imaginary plane (e.g., the positive or negative direction of the first axis D1), the aforementioned imaginary position (i.e., the point of application of the stabilizing force F) is located within a first imaginary triangle T1 defined by the first connecting portion 1530-1, the second connecting portion 1530-2, and the third connecting portion 1530-3. The direction of the stabilizing force F is not parallel to the first imaginary plane, and the first imaginary plane is parallel to the plane defined by the second axis D2 and the third axis D3.

With reference to FIG. 4 and FIG. 7, the second connecting element 1520 is movable relative to the fixed portion 1100 via the fifth connecting portion 1530-5, the sixth connecting portion 1530-6, and the tenth connecting portion 1530-10. The first connecting element 1510 is movable relative to the fixed portion 1100 via the seventh connecting portion 1530-7, the eighth connecting portion 1530-8, and the ninth connecting portion 1530-9.

As shown in FIG. 4, a second imaginary plane (which is parallel to the plane defined by the second axis D2 and the third axis D3) is defined by the fifth connecting portion 1530-5, the seventh connecting portion 1530-7, and the eighth connecting portion 1530-8.

When viewed along a direction perpendicular to the first axis D1 (e.g., a direction parallel to the second imaginary plane), the first imaginary plane described in FIG. 7 (which is defined by the first connecting portion 1530-1, the second connecting portion 1530-2 and the third connecting portion 1530-3) and the second imaginary plane described in FIG. 4 (which is formed by the fifth connecting portion 1530-5, the seventh connecting portion 1530-7 and the eighth connecting portion 1530-8) are parallel to each other but do not overlap.

As shown in FIG. 4, when viewed along a direction perpendicular to the second imaginary plane (e.g., along the positive or negative direction of the first axis D1), the aforementioned imaginary position (i.e., the point of application of the stabilizing force F) is located within a second imaginary triangle T2 defined by the fifth connecting portion 1530-5, the seventh connecting portion 1530-7, and the eighth connecting portion 1530-8.

With reference to FIG. 4 and FIG. 7, when viewed along a direction perpendicular to the second imaginary plane (e.g., along the positive or negative direction of the first axis D1), the first imaginary triangle T1 and the second imaginary triangle T2 have non-overlapping portions.

As shown in FIG. 4, the fixed portion 1100 has a first corner 1100-1, a second corner 1100-2, a third corner 1100-3, and a fourth corner 1100-4. The third corner 1100-3 is not adjacent to the first corner 1100-1, and the fourth corner 1100-4 is not adjacent to the second corner 1100-2. Specifically, the third corner 1100-3 is located in a diagonal position to the first corner 1100-1, and the fourth corner 1100-4 is located in a diagonal position to the second corner 1100-2.

Please refer to FIG. 4 and FIG. 7 together. When viewed along the first axis D1, the first connecting portion 1530-1 (FIG. 7) is located at the first corner 1100-1 (FIG. 4). When viewed along the first axis D1, the third connecting portion 1530-3 (FIG. 7) is located at the third corner 1100-3 (FIG. 4). When viewed along the first axis D1, the second connecting portion 1530-2 (FIG. 7) is located at the second corner 1100-2 (FIG. 4).

As shown in FIG. 4, when viewed along the first axis D1, the fifth connecting portion 1530-5 is located at the first corner 1100-1. When viewed along the first axis D1, the seventh connecting portion 1530-7 is located at the second corner 1100-2. When viewed along the first axis D1, the eighth connecting portion 1530-8 is located at the third corner 1100-3. It should be understood that when viewed along the first axis D1, the second connecting portion 1530-2 (FIG. 7) does not overlap with the seventh connecting portion 1530-7 (FIG. 4).

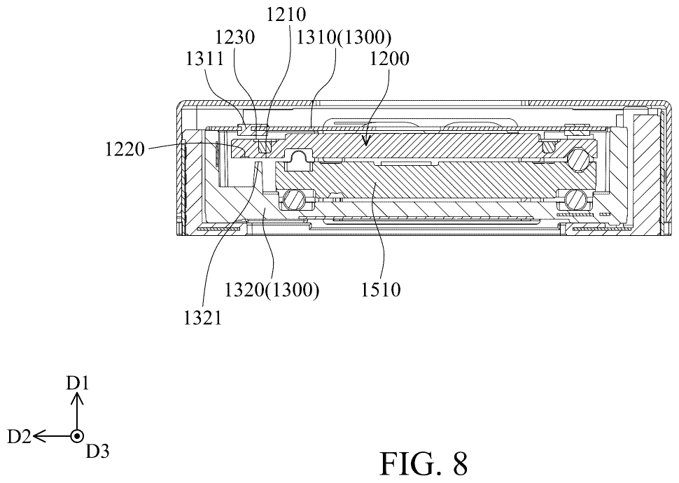

FIG. 8 shows a cross-sectional view of the optical element driving mechanism 1000 taken along line B-B′ of FIG. 1. It should be understood that the optical element driving mechanism 1000 further includes a stopping component for limiting the range of motion of the first movable portion 1200. The stopping component includes a first stopping portion and a second stopping portion.

As shown in FIG. 8, the first movable portion 1200 includes a first movable portion surface 1210 and a first stopping portion 1220 (which can be regarded as the first stopping portion of the stopping component in this embodiment). The body 1320 of the second movable portion 1300 includes a second stopping portion 1321 (which can be regarded as the second stopping portion of the stopping component in this embodiment). In other words, the second stopping portion of the stopping component is formed on the body 1320 of the second movable portion 1300.

According to some embodiments of the present disclosure, the first movable portion surface 1210 of the first movable portion 1200 faces the first connecting element 1510 or the second connecting element 1520, and the first stopping portion 1220 is formed on the first movable portion surface 1210. When the first movable portion 1200 is located in the first limit position, the first stopping portion 1220 and the second stopping portion 1321 contact each other.

According to some embodiments of the present disclosure, the first stopping portion 1220 is movable relative to the first connecting element 1510, and the first stopping portion 1220 is movable relative to the second connecting element 1520 (FIG. 7). The first connecting element 1510 is movable relative to the second stopping portion 1321, and the second connecting element 1520 (FIG. 7) is movable relative to the second stopping portion 1321. When viewed along the first axis D1, the first stopping portion 1220 is located at the fourth corner 1100-4 of the fixed portion 1100 shown in FIG. 4.

According to some embodiments of the present disclosure, the stopping component further includes a third stopping portion and a fourth stopping portion. As shown in FIG. 8, the first movable portion 1200 further includes a third stopping portion 1230 (in this embodiment, it may be regarded as the third stopping portion of the stopping component). The upper cover 1310 of the second movable portion 1300 includes a fourth stopping portion 1311 (in this embodiment, it may be regarded as the fourth stopping portion of the stopping component).

According to some embodiments of the present disclosure, when viewed along a direction perpendicular to the first movable portion surface 1210 (e.g., the direction of the positive and negative first axis D1), the first stopping portion 1220 and the third stopping portion 1230 at least partially overlap. In other words, the first stopping portion 1220 and the third stopping portion 1230 are respectively located at opposite ends of the first movable portion 1200 on the first axis D1. When the first movable portion 1200 is located in the second limit position, the third stopping portion 1230 and the fourth stopping portion 1311 contact each other.

Referring back to FIG. 7, the first connecting element 1510 includes a first corresponding portion 1510-1, a second corresponding portion 1510-2, a first extending portion 1511, a second extending portion 1512, and a middle portion 1513. The second connecting element 1520 includes a third corresponding portion 1520-1, a fourth corresponding portion 1520-2, a first extending portion 1521, a second extending portion 1522, and a middle portion 1523.

As shown in FIG. 7, the first corresponding portion 1510-1 corresponds to the first connecting portion 1530-1, and the second corresponding portion 1510-2 corresponds to the second connecting portion 1530-2. Specifically, the first corresponding portion 1510-1 and the second corresponding portion 1510-2 are grooves for accommodating the first connecting portion 1530-1 and the second connecting portion 1530-2, respectively.

As shown in FIG. 7, the extending direction of the first extending portion 1511 is perpendicular to the extending direction of the second extending portion 1512. The first extending portion 1511 and the second extending portion 1512 are connected by the middle portion 1513. The first corresponding portion 1510-1 is located in the middle portion 1513. The second corresponding portion 1510-2 is located at the end of the first extending portion 1511 away from the middle portion 1513.

Similarly, the third corresponding portion 1520-1 and the fourth corresponding portion 1520-2 are grooves for accommodating the third connecting portion 1530-3 and the fourth connecting portion 1530-4, respectively. The extending direction of the first extending portion 1521 is perpendicular to the extending direction of the second extending portion 1522.

As shown in FIG. 7, the first extending portion 1521 and the second extending portion 1522 are connected by the middle portion 1523. The third corresponding portion 1520-1 is located at the middle portion 1523. The fourth corresponding portion 1520-2 is located at an end of the first extending portion 1521 away from the middle portion 1523.

Referring back to FIG. 5, the first connecting element 1510 further includes a fifth corresponding portion 1510-3, a sixth corresponding portion 1510-4, and a tenth corresponding portion 1510-5. The second connecting element 1520 further includes a seventh corresponding portion 1520-3, an eighth corresponding portion 1520-4, and a ninth corresponding portion 1520-5.

As shown in FIG. 5, the fifth corresponding portion 1510-3 corresponds to the fifth connecting portion 1530-5. The sixth corresponding portion 1510-4 corresponds to the sixth connecting portion 1530-6. The tenth corresponding portion 1510-5 corresponds to the tenth connecting portion 1530-10. In detail, the fifth corresponding portion 1510-3, the sixth corresponding portion 1510-4 and the tenth corresponding portion 1510-5 are grooves for accommodating the fifth connecting portion 1530-5, the sixth connecting portion 1530-6 and the tenth connecting portion 1530-10, respectively.

As shown in FIG. 5, the fifth corresponding portion 1510-3 is located at the middle portion 1513. The sixth corresponding portion 1510-4 is located at the end of the first extending portion 1511 away from the middle portion 1513. The tenth connecting portion 1530-10 is located at the end of the second extending portion 1512 away from the middle portion 1513.

Similarly, the seventh corresponding portion 1520-3 corresponds to the seventh connecting portion 1530-7. The eighth corresponding portion 1520-4 corresponds to the eighth connecting portion 1530-8. The ninth corresponding portion 1520-5 corresponds to the ninth connecting portion 1530-9. In detail, the seventh corresponding portion 1520-3, the eighth corresponding portion 1520-4 and the ninth corresponding portion 1520-5 are grooves for accommodating the seventh connecting portion 1530-7, the eighth connecting portion 1530-8 and the ninth connecting portion 1530-9 respectively.

As shown in FIG. 5, the seventh corresponding portion 1520-3 is located at the end of the first extending portion 1521 away from the middle portion 1523. The eighth corresponding portion 1520-4 is located at the middle portion 1523. The ninth corresponding portion 1520-5 is located at the end of the second extending portion 1522 away from the middle portion 1523.

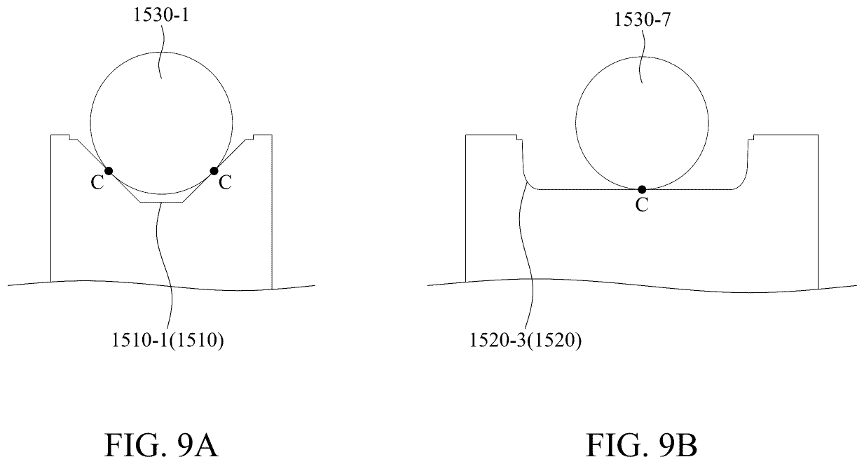

FIG. 9A and FIG. 9B are schematic cross-sectional views of the first corresponding portion 1510-1 of the first connecting element 1510 and the seventh corresponding portion 1520-3 of the second connecting element 1520, respectively, according to some embodiments of the present disclosure.

As shown in FIG. 9A, the first corresponding portion 1510-1 is a V-shaped groove for accommodating the first connecting portion 1530-1. Specifically, there are two contact points C between the first corresponding portion 1510-1 and the first connecting portion 1530-1.

As shown in FIG. 9B, the seventh corresponding portion 1520-3 is a U-shaped groove for accommodating the seventh connecting portion 1530-7. Specifically, there is a contact point C between the seventh corresponding portion 1520-3 and the seventh connecting portion 1530-7.

In some embodiments of the present disclosure, the number of contact points C (two) between the first corresponding portion 1510-1 and the first connecting portion 1530-1 is the same as the number of contact points (two) between the second corresponding portion 1510-2 (FIG. 7) and the second connecting portion 1530-2 (FIG. 7). The number of contact point (one) between the seventh corresponding portion 1520-3 and the seventh connecting portion 1530-7 is different from the number of contact points (two) between the eighth corresponding portion 1520-4 (FIG. 5) and the eighth connecting portion 1530-8 (FIG. 5).

In summary, the optical element driving mechanism disclosed herein provides the required degrees of freedom for movement by disposing connecting portions (e.g., balls) respectively above and below the first connecting element and the second connecting element. With this configuration, when the first connecting element is driven to move the first movable portion in a specific direction, the second connecting element is decoupled from the movement of the first movable portion by virtue of the degrees of freedom provided by the connecting portions, thereby maintaining its original position without being displaced. The same applies in the reverse situation. This design effectively enhances the independence and precision of multi-axis driving control, prevents interference between different driving paths, and facilitates stable and highly efficient optical element positioning control, thereby improving the overall operational performance and reliability of the module.

By forming a tight-fit structure at some of the corresponding portions using V-shaped grooves and a loose-fit structure at other corresponding portions using U-shaped grooves, both positioning stability and the required degrees of freedom for movement can be achieved. This design effectively enables decoupled control among different axes, prevents interference and jamming, and improves the smoothness of movement and positioning accuracy of the optical element driving mechanism.

In addition, the present disclosure provides a first stabilizing portion and a second stabilizing portion to apply a stabilizing force among the first movable portion, the second movable portion, and the connecting component, thereby further preventing the first connecting element and the second connecting element from toppling during movement. This design contributes to enhancing the mechanical stability of the overall structure and ensures balance and reliability of the optical element driving mechanism during operation.

While the embodiments of the present invention and their advantages have been disclosed above, it should be understood that various modifications, substitutions, and alterations can be made by those skilled in the art without departing from the spirit and scope of the present invention. Furthermore, the scope of protection of the present invention is not limited to the specific processes, machines, manufacture, compositions of matter, devices, methods, and steps described in the specification. Rather, those skilled in the art will recognize, based on the teachings of the present disclosure, that existing or future processes, machines, manufacture, compositions of matter, devices, methods, and steps that perform substantially the same function or achieve substantially the same result as those described in the embodiments herein may be utilized within the scope of the present invention. Therefore, the scope of protection of the present invention includes the aforementioned processes, machines, manufacture, compositions of matter, devices, methods, and steps. In addition, each claim constitutes a separate embodiment, and the scope of the present invention also includes combinations of the claims and embodiments.

What is claimed is:

1. An optical element driving mechanism, comprising:
a first movable portion, configured to connect an optical element;
a fixed portion, wherein the first movable portion is movable relative to the fixed portion;
a driving component for driving the first movable portion to move relative to the fixed portion; and
a connecting component, wherein the first movable portion is movable relative to the fixed portion via the connecting component.

2. The optical element driving mechanism as claimed in claim 1, wherein the connecting component comprises:
a first connecting element, wherein the first movable portion is movable relative to the fixed portion via the first connecting element; and
a second connecting element, wherein the first movable portion is movable relative to the fixed portion via the second connecting element;
wherein the first connecting element is movable relative to the fixed portion, and the second connecting element is movable relative to the fixed portion.

3. The optical element driving mechanism as claimed in claim 2, wherein the connecting component further comprises:
a first connecting portion, wherein the first movable portion is movable relative to the first connecting element via the first connecting portion;
a second connecting portion, wherein the first movable portion is movable relative to the first connecting element via the second connecting portion; and
a third connecting portion, wherein the first movable portion is movable relative to the second connecting element via the third connecting portion.

4. The optical element driving mechanism as claimed in claim 3, wherein a first imaginary plane is defined by the first connecting portion, the second connecting portion, and the third connecting portion.

5. The optical element driving mechanism as claimed in claim 4, further comprising a stabilizing component for applying a stabilizing force to the first movable portion, thereby maintaining continuous contact with the connecting component.

6. The optical element driving mechanism as claimed in claim 5, wherein when viewed along a direction perpendicular to the first imaginary plane, a force application point of the stabilizing force is located in an imaginary position.

7. The optical element driving mechanism as claimed in claim 6, wherein when viewed along the direction perpendicular to the first imaginary plane, the imaginary position is located within a first imaginary triangle defined by the first connecting portion, the second connecting portion, and the third connecting portion.

8. The optical element driving mechanism as claimed in claim 7, wherein the direction of the stabilizing force is not parallel to the first imaginary plane.

9. The optical element driving mechanism as claimed in claim 7, wherein the stabilizing component further comprises:
a first stabilizing portion, for generating a first stabilizing force; and
a second stabilizing portion, for generating a second stabilizing force;
wherein the stabilizing force is at least composed of the first stabilizing force and the second stabilizing force.

10. The optical element driving mechanism as claimed in claim 9, wherein the first stabilizing portion comprises:
a first stabilizing element fixedly disposed on the first movable portion; and
a second stabilizing element configured to generate the first stabilizing force together with the first stabilizing element.

11. The optical element driving mechanism as claimed in claim 10, wherein the second stabilizing element is movable relative to the fixed portion;
wherein the first stabilizing element is movable relative to the second stabilizing element;
wherein the first connecting element is movable relative to the second stabilizing element;
wherein the second connecting element is movable relative to the second stabilizing element.

12. The optical element driving mechanism as claimed in claim 10, further comprising a second movable portion movable relative to the fixed portion, and the second stabilizing element is fixedly disposed on the second movable portion.

13. The optical element driving mechanism as claimed in claim 12, wherein the connecting component further comprises:
a fifth connecting portion, wherein the first connecting element is movable relative to the fixed portion via the fifth connecting portion;
a seventh connecting portion, wherein the first connecting element is movable relative to the fixed portion via the seventh connecting portion; and
an eighth connecting portion, wherein the second connecting element is movable relative to the fixed portion via the eighth connecting portion;
wherein a second imaginary plane is defined by the fifth connecting portion, the seventh connecting portion and the eighth connecting portion;
wherein when viewed along a direction parallel to the second imaginary plane, the first imaginary plane and the second imaginary plane are parallel to each other but do not overlap;
wherein when viewed along a direction perpendicular to the second imaginary plane, the imaginary position is located within a second imaginary triangle defined by the fifth connecting portion, the seventh connecting portion and the eighth connecting portion;
when viewed along the direction perpendicular to the second imaginary plane, the first imaginary triangle and the second imaginary triangle have non-overlapping portions.

14. The optical element driving mechanism as claimed in claim 13, further comprising a stopping component for limiting a range of motion of the first movable portion, wherein the stopping component comprises a first stopping portion and a second stopping portion, and when the first movable portion is located in a first limit position, the first stopping portion is in contact with the second stopping portion, the first stopping portion is movable relative to the first connecting element, the first stopping portion is movable relative to the second connecting element, the first connecting element is movable relative to the second stopping portion, the second connecting element is movable relative to the second stopping portion, a first movable portion surface of the first movable portion faces the first connecting element or the second connecting element, and the first stopping portion is formed on the first movable portion surface.

15. The optical element driving mechanism as claimed in claim 14, wherein the stopping component further comprises a third stopping portion and a fourth stopping portion, wherein when the first movable portion is located in a second limit position, the third stopping portion is in contact with the fourth stopping portion; when viewed along a direction perpendicular to the first movable portion surface, the first stopping portion and the third stopping portion at least partially overlap, and the second stopping portion is formed on the second movable portion.

16. The optical element driving mechanism as claimed in claim 14, wherein the connecting component further comprises:
a first corresponding portion, corresponding to the first connecting portion; and
a second corresponding portion, corresponding to the second connecting portion;
wherein the number of contact points between the first corresponding portion and the first connecting portion is equal to the number of contact points between the second corresponding portion and the second connecting portion.

17. The optical element driving mechanism as claimed in claim 16, wherein the connecting component further comprises:
a seventh corresponding portion, corresponding to the seventh connecting portion; and
an eighth corresponding portion, corresponding to the eighth connecting portion;
wherein the number of contact points between the seventh corresponding portion and the seventh connecting portion is different from the number of contact points between the eighth corresponding portion and the eighth connecting portion.

18. The optical element driving mechanism as claimed in claim 16, wherein when viewed along a first axis, the fixed portion has a first corner, a second corner, a third corner, and a fourth corner, wherein the third corner is not adjacent to the first corner, and the fourth corner is not adjacent to the second corner.

19. The optical element driving mechanism as claimed in claim 18, wherein when viewed along the first axis, the first connecting portion is located at the first corner;
wherein when viewed along the first axis, the third connecting portion is located at the third corner;
when viewed along the first axis, the second connecting portion is located at the second corner;
when viewed along the first axis, the second connecting portion does not overlap with the seventh connecting portion;
and when viewed along the first axis, the first stopping portion is located at the fourth corner.

20. The optical element driving mechanism as claimed in claim 18, wherein when viewed along the first axis, the fifth connecting portion is located at the first corner;
when viewed along the first axis, the eighth connecting portion is located at the third corner, and
when viewed along the first axis, the seventh connecting portion is located at the second corner.
